(19) United States
(12) Patent Application Publication
(10) Pub. No.: US 2023/0085540 A1
(43) Pub. Date: Mar. 16, 2023

(54) CYCLIC PREFIX EXTENSION FOR SOUNDING REFERENCE SIGNAL TRANSMISSION IN NR-U

(71) Applicant: QUALCOMM Incorporated, San Diego, CA (US)

(72) Inventors: Changlong XU, Beijing (CN); Xiaoxia ZHANG, San Diego, CA (US); Jing SUN, San Diego, CA (US)

(21) Appl. No.: 17/759,841

(22) PCT Filed: Mar. 12, 2020
(86) PCT No.: PCT/CN2020/078953

§ 371 Date: Jul. 29, 2022

(51) Int. Cl. H04L 5/00; H04W 74/08

(52) U.S. Cl. CPC H04L 5/0051; H04W 74/0808

(57) ABSTRACT

Various aspects of the present disclosure generally relate to wireless communication. In some aspects, a user equipment (UE) may receive an uplink grant that schedules a sounding reference signal (SRS) transmission and a physical uplink shared channel (PUSCH) transmission and indicates one or more parameters for determining a cyclic prefix extension. The UE may determine the cyclic prefix extension based at least in part on the one or more parameters. The UE may transmit the SRS transmission with the cyclic prefix extension after performing a listen before talk (LBT) procedure. Numerous other aspects are provided.

### FIELD OF THE DISCLOSURE

Aspects of the present disclosure generally relate to wireless communication and to techniques and apparatuses for determining a cyclic prefix extension for a sounding reference signal transmission in New Radio Unlicensed (NR-U).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving an uplink grant that: schedules a sounding reference signal (SRS) transmission and a physical uplink shared channel (PUSCH) transmission, and indicates one or more parameters for determining a cyclic prefix extension; determining the cyclic prefix extension based at least in part on the one or more parameters; and transmitting the SRS transmission with the cyclic prefix extension after performing a listen before talk (LBT) procedure.

In some aspects, a method of wireless communication, performed by a UE, may include receiving an uplink grant that: schedules a PUSCH transmission, and indicates one or more parameters for determining a first cyclic prefix extension; determining a second cyclic prefix extension for an SRS transmission to be transmitted after a timing gap after the PUSCH transmission; and transmitting the SRS transmission with the second cyclic prefix extension after transmitting the PUSCH transmission.

In some aspects, a method of wireless communication, performed by a UE, may include receiving a downlink control information (DCI) communication that: schedules an SRS transmission, and indicates one or more parameters for determining a cyclic prefix extension; determining the cyclic prefix extension based at least in part on the one or more parameters; and transmitting an SRS transmission with the cyclic prefix extension after performing an LBT procedure.

In some aspects, a UE for wireless communication may include a memory and one or more processors operatively coupled to the memory. The memory and the one or more processors may be configured to receive an uplink grant that schedules an SRS transmission and a PUSCH transmission and indicates one or more parameters for determining a cyclic prefix extension; determine the cyclic prefix extension based at least in part on the one or more parameters; and transmit the SRS transmission with the cyclic prefix extension after performing an LBT procedure.

In some aspects, a UE for wireless communication may include a memory and one or more processors operatively coupled to the memory. The memory and the one or more processors may be configured to receive an uplink grant that schedules a PUSCH transmission and indicates one or more parameters for determining a first cyclic prefix extension; determine a second cyclic prefix extension for an SRS transmission to be transmitted after a timing gap after the PUSCH transmission; and transmit the SRS transmission with the second cyclic prefix extension after transmitting the PUSCH transmission.

In some aspects, a UE for wireless communication may include a memory and one or more processors operatively coupled to the memory. The memory and the one or more processors may be configured to receive a DCI communication that schedules an SRS transmission and indicates one or more parameters for determining a cyclic prefix extension; determine the cyclic prefix extension based at least in part on the one or more parameters; and transmit an SRS transmission with the cyclic prefix extension after performing an LBT procedure.

In some aspects, a non-transitory computer-readable medium may store one or more instructions for wireless communication. The one or more instructions, when executed by one or more processors of a UE, may cause the one or more processors to receive an uplink grant that: schedules an SRS transmission and a PUSCH transmission, and indicates one or more parameters for determining a cyclic prefix extension; determine the cyclic prefix extension based at least in part on the one or more parameters; and transmit the SRS transmission with the cyclic prefix extension after performing an LBT procedure.

In some aspects, a non-transitory computer-readable medium may store one or more instructions for wireless communication. The one or more instructions, when executed by one or more processors of a UE, may cause the one or more processors to receive an uplink grant that: schedules a PUSCH transmission, and indicates one or more parameters for determining a first cyclic prefix extension; determine a second cyclic prefix extension for an SRS transmission to be transmitted after a timing gap after the PUSCH transmission; and transmit the SRS transmission with the second cyclic prefix extension after transmitting the PUSCH transmission.

In some aspects, a non-transitory computer-readable medium may store one or more instructions for wireless communication. The one or more instructions, when executed by one or more processors of a UE, may cause the one or more processors to receive a DCI communication that: schedules an SRS transmission, and indicates one or more parameters for determining a cyclic prefix extension; determine the cyclic prefix extension based at least in part on the one or more parameters; and transmit an SRS transmission with the cyclic prefix extension after performing an LBT procedure.

In some aspects, an apparatus for wireless communication may include means for receiving an uplink grant that schedules an SRS transmission and a PUSCH transmission and indicates one or more parameters for determining a cyclic prefix extension; means for determining the cyclic prefix extension based at least in part on the one or more parameters; and means for transmitting the SRS transmission with the cyclic prefix extension after performing an LBT procedure.

In some aspects, an apparatus for wireless communication may include means for receiving an uplink grant that schedules a PUSCH transmission and indicates one or more parameters for determining a first cyclic prefix extension; means for determining a second cyclic prefix extension for an SRS transmission to be transmitted after a timing gap after the PUSCH transmission; and means for transmitting the SRS transmission with the second cyclic prefix extension after transmitting the PUSCH transmission.

In some aspects, an apparatus for wireless communication may include means for receiving a DCI communication that schedules an SRS transmission and indicates one or more parameters for determining a cyclic prefix extension; means for determining the cyclic prefix extension based at least in part on the one or more parameters; and means for transmitting an SRS transmission with the cyclic prefix extension after performing an LBT procedure.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIGS. 3A-3C, 4A-4C, 5A-5C, and 6A-6C are diagrams illustrating examples of determining a cyclic prefix extension for a sounding reference signal transmission in New Radio Unlicensed (NR-U), in accordance with various aspects of the present disclosure.

FIGS. 7-9 are diagrams illustrating example processes performed, for example, by a UE, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

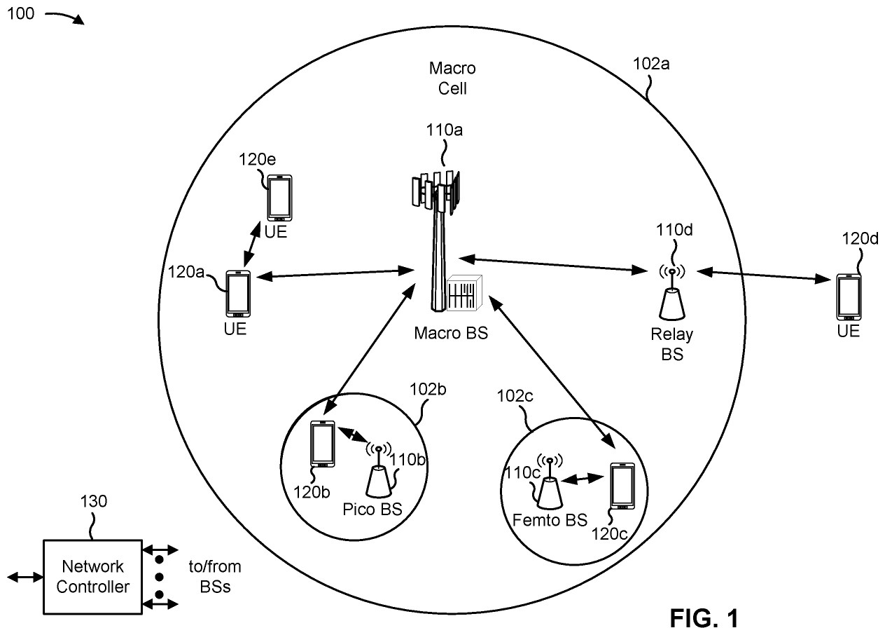

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

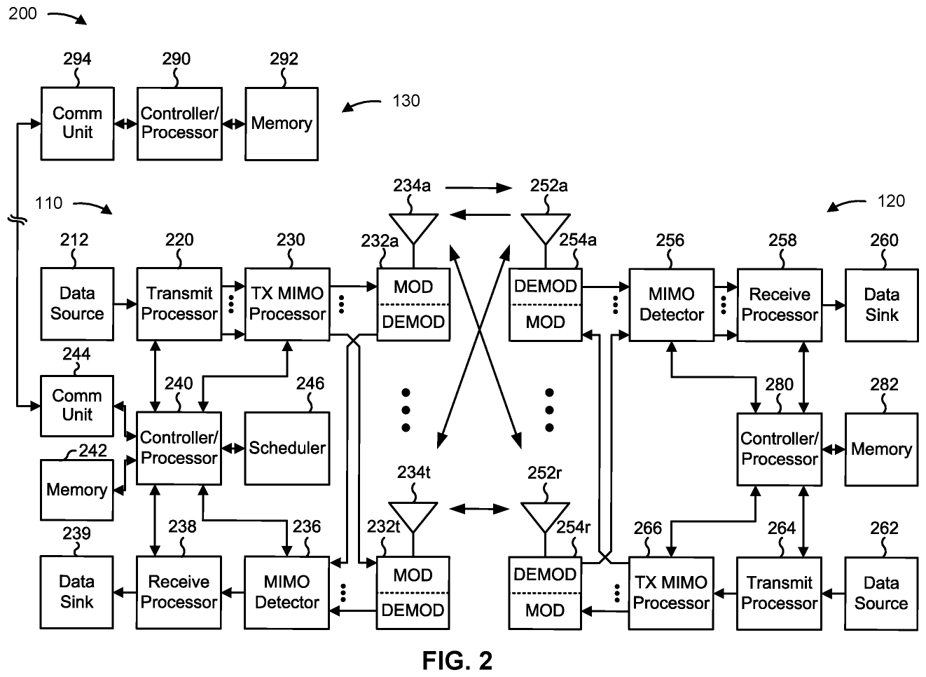

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MC S(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

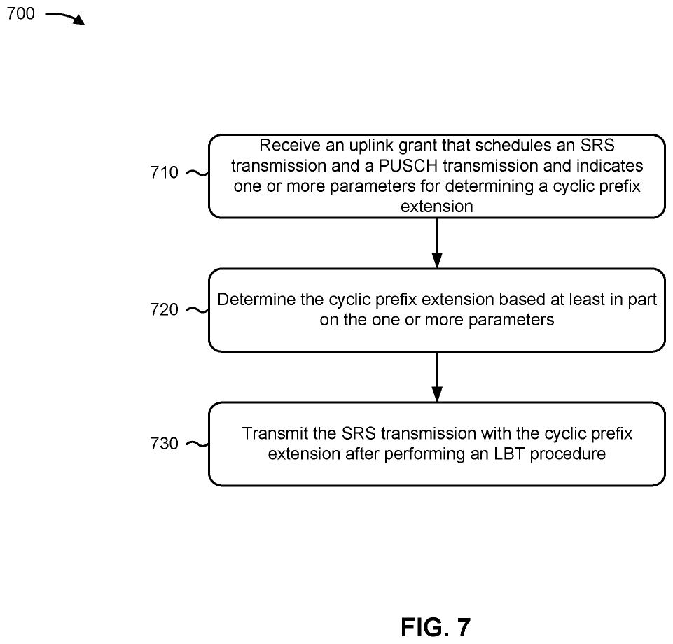

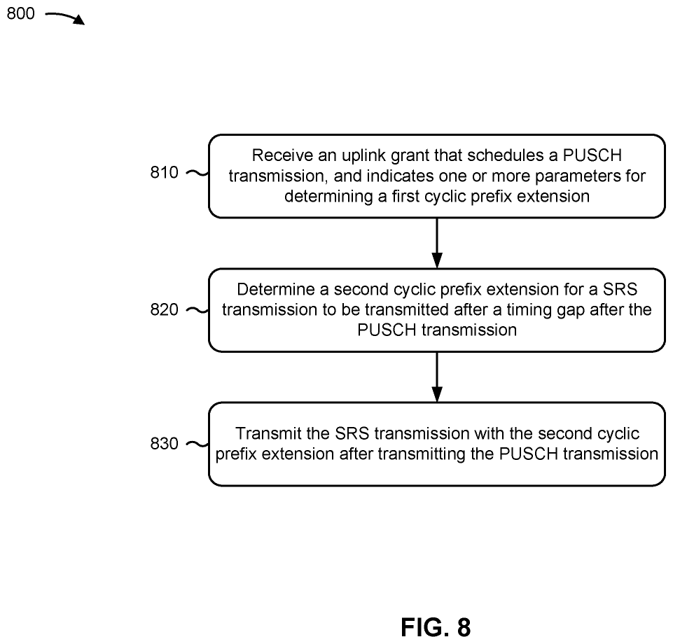

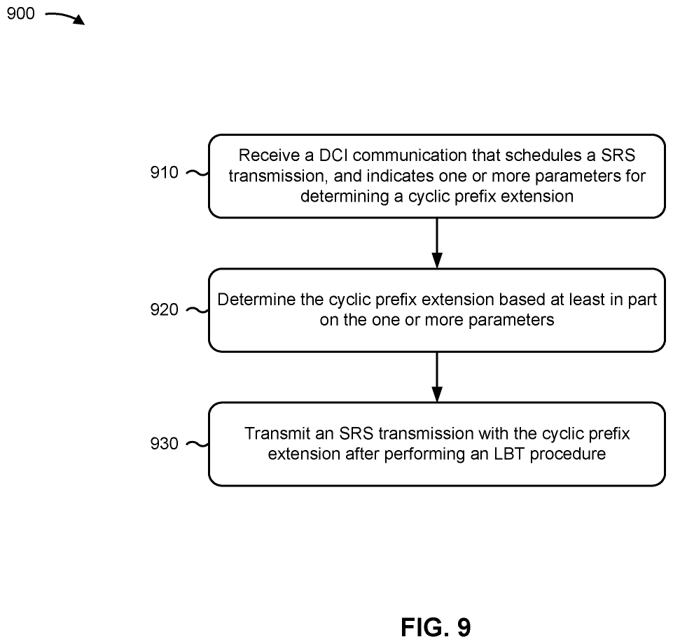

Controller/processor 240 of base station 110, controller/processor 280 of UE 120, and/or any other component(s) of FIG. 2 may perform one or more techniques associated with determining a cyclic prefix extension for a sounding reference signal (SRS) transmission in New Radio Unlicensed (NR-U), as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 700 of FIG. 7, process 800 of FIG. 8, process 900 of FIG. 9, and/or other processes as described herein. A scheduler 246 may schedule UEs for data transmission on the downlink and/or uplink.

In some aspects, UE 120 may include means for receiving an uplink grant that schedules an SRS transmission and a physical uplink shared channel (PUSCH) transmission and indicates one or more parameters for determining a cyclic prefix extension, means for determining the cyclic prefix extension based at least in part on the one or more parameters, means for transmitting the SRS transmission with the cyclic prefix extension after performing a listen before talk (LBT) procedure, and/or the like. In some aspects, UE 120 may include means for receiving an uplink grant that schedules a PUSCH transmission and indicates one or more parameters for determining a first cyclic prefix extension determining a second cyclic prefix extension for an SRS transmission to be transmitted after a timing gap after the PUSCH transmission, means for transmitting the SRS transmission with the second cyclic prefix extension after transmitting the PUSCH transmission, and/or the like. In some aspects, UE 120 may include means for receiving a downlink control information (DCI) communication that schedules an SRS transmission and indicates one or more parameters for determining a cyclic prefix extension, means for determining the cyclic prefix extension based at least in part on the one or more parameters, means for transmitting an SRS transmission with the cyclic prefix extension after performing an LBT procedure, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

ABS and UE may communicate in a shared spectrum frequency band or unlicensed frequency band, such as a Long Term Evolution (LTE) licensed assisted access (LAA) frequency band, an NR-U frequency band, and/or the like. The shared spectrum frequency band may include an International Telecommunication Union (ITU) radio spectrum, a wireless local area network (WLAN) frequency band, an Institute of Electrical and Electronics Engineers (IEEE) radar frequency band, and/or another type of frequency band and/or spectrum on which different types of wireless communication may be performed.

To coordinate the radio resources of a shared spectrum frequency band among a plurality of wireless communication devices (e.g., UEs, BSs, and/or other types of devices), a wireless communication device may perform an LBT procedure to determine whether the shared spectrum frequency band is idle prior to transmitting on the shared spectrum frequency band. If the wireless communication device determines that, after a threshold amount of time, the shared spectrum frequency band is idle, the wireless communication device may proceed with transmitting on the shared spectrum frequency band. Otherwise, if the wireless communication device determines that the shared spectrum frequency band is in use by another wireless communication device, the wireless communication device may wait for a period of time before reattempting the LBT procedure.

When performing a transmission on a shared spectrum frequency band, a wireless communication device may transmit a cyclic prefix extension prior to (or along with) the transmission to facilitate alignment of orthogonal frequency division multiplexing (OFDM) symbols and to reduce inter-symbol interference (ISI). After performing a transmission on the shared spectrum frequency band, the wireless communication device may need to perform another LBT procedure prior to a subsequent transmission if the timing gap between the transmission and the subsequent transmission does not satisfy a threshold LBT timing gap. The threshold LBT timing gap may be configured to reduce the risk of collisions on the shared spectrum frequency band if another wireless communication device concludes that the shared spectrum frequency band is idle while performing an LBT procedure during the timing gap between the transmission and the subsequent transmission.

In some cases, some wireless networks may support flexible configuration of SRS transmissions on a shared spectrum frequency band. For example, while some wireless networks may limit the location of an SRS transmission to the last 6 symbols of a slot in which an associated PUSCH transmission is to occur, other wireless networks may support configuring the SRS transmission to start at any symbol within the slot via extended radio resource control (RRC) configuration parameters such as a startPosition parameter (which may indicate the starting symbol of an SRS transmission). In these cases, a BS may be permitted to configure the startPosition parameter to have a value range of 0-13.

While developments in SRS transmission configuration in a wireless network provide greater flexibility in scheduling SRS transmissions in a shared spectrum frequency band, the ability to vary the starting symbol of an SRS transmission may lead to gaps between the SRS transmission and an associated PUSCH transmission, which in turn may increase the quantity of LBT procedures that a UE may need to perform to transmit both the SRS transmission and the PUSCH transmission. Moreover, while the UE may be capable of determining a cyclic prefix extension for the PUSCH transmission, the UE may be unable to determine a cyclic prefix extension for the SRS transmission.

Some aspects described herein provide techniques and apparatuses for determining a cyclic prefix extension for a sounding reference signal transmission in NR-U and/or another shared spectrum frequency band. In some aspects, a BS (e.g., a BS 110) may indicate, in an uplink grant that schedules an SRS transmission and an associated PUSCH transmission, one or more parameters for determining a cyclic prefix extension. A UE (e.g., a UE 120) may receive the uplink grant, may determine the cyclic prefix extension based at least in part on the one or more parameters, and may transmit the SRS transmission or the PUSCH transmission with the cyclic prefix extension. If a timing gap occurs between the SRS transmission and the PUSCH transmission, the UE is capable of determining another cyclic prefix extension for the latter transmission such that another LBT procedure is not needed between the SRS transmission and the PUSCH transmission. In this way, the UE is capable of determining a cyclic prefix extension for SRS transmissions in a shared spectrum frequency band, is capable of determining a cyclic prefix between SRS transmissions and PUSCH transmissions to reduce the quantity of LBT procedures that are to be performed by the UE, and/or the like. This, performing fewer LBT procedures reduces the consumption of processing and memory resources of the UE for performing LBT procedures.

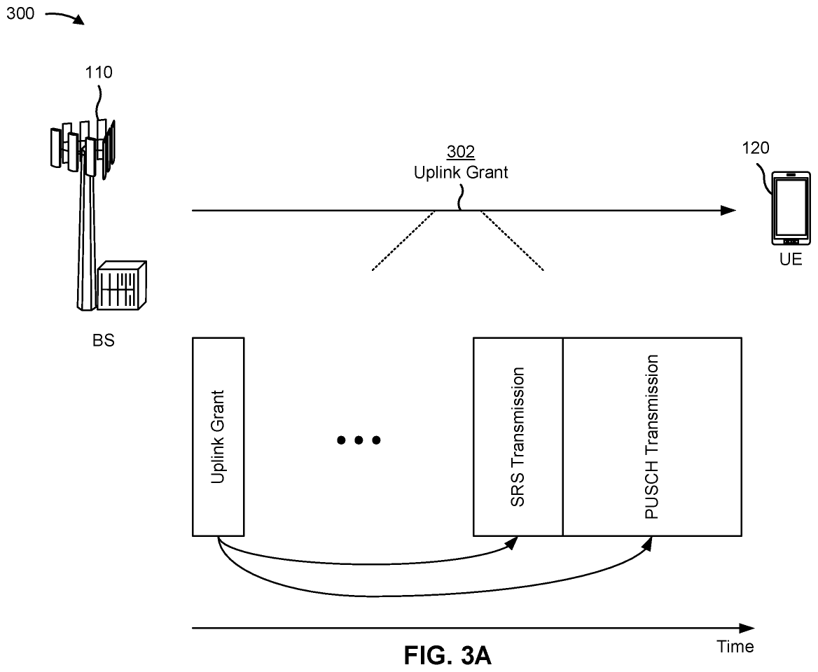

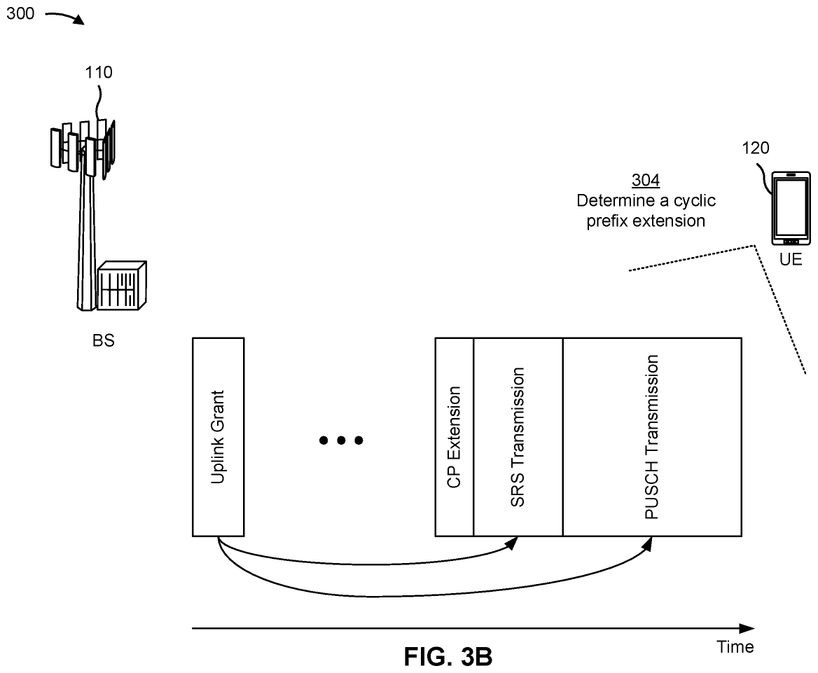

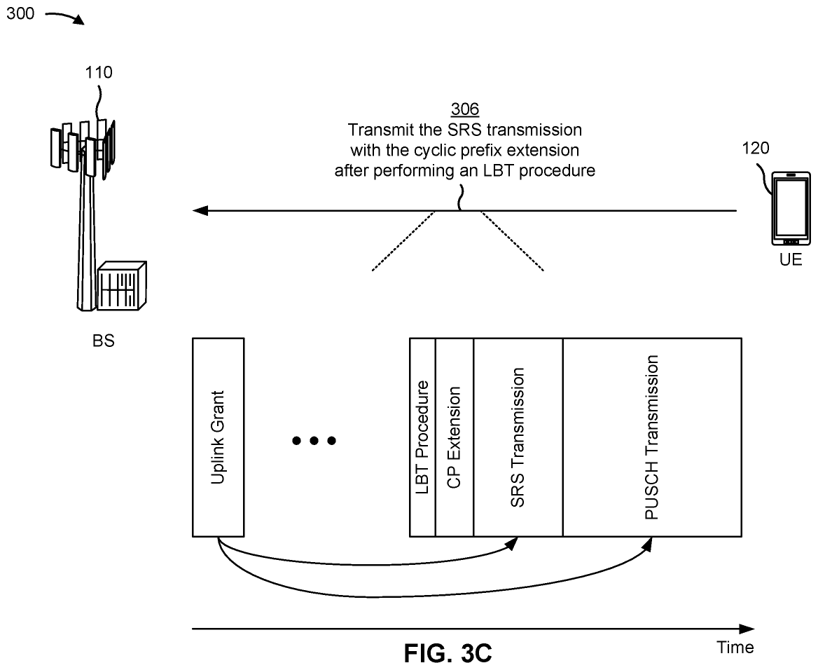

FIGS. 3A-3C are diagrams illustrating one or more examples 300 of determining a cyclic prefix extension for a sounding reference signal transmission in NR-U, in accordance with various aspects of the present disclosure. As shown in FIGS. 3A-3C, example(s) 300 include communication between a BS 110 (e.g., a BS 110 illustrated and described above in connection with FIGS. 1 and/or 2) and a UE 120 (e.g., a UE 120 illustrated and described above in connection with FIGS. 1 and/or 2). The BS 110 and the UE 120 may be included in a wireless network, such as wireless network 100. The BS 110 and the UE 120 may communicate on a wireless access link, which may include an uplink and a downlink. In some aspects, the BS 110 and the UE 120 communicate via a shared radio frequency spectrum band, such as an NR-U band or another type of shared radio frequency spectrum band on which the BS 110, the UE 120, and other wireless communication devices perform an LBT procedure before transmitting on the shared radio frequency spectrum band.

As shown in FIG. 3A, and by reference number 302, the BS 110 may transmit an uplink grant to the UE 120. The uplink grant may schedule a PUSCH transmission and an associated SRS transmission for the UE 120. For example, the uplink grant may identify time domain resources (e.g., one or more slots, one or more symbols, and/or the like) and/or frequency domain resources (e.g., one or more resource blocks, one or more resource elements, one or more subcarriers, one or more component carriers, and/or the like) in which to perform the PUSCH transmission and the SRS transmission. In some aspects, the uplink grant is included in DCI and/or in a physical downlink control channel (PDCCH) communication.

As further shown in FIG. 3A, the uplink grant may schedule the SRS transmission and the PUSCH transmission as back-to-back transmissions. In this case, the PUSCH transmission and the SRS transmission are to be performed in adjacent time domain resources or adjacent groups or sets of time domain resources. While FIG. 3A illustrates the SRS transmission being scheduled to be transmitted before the PUSCH transmission, example(s) 300 may include the PUSCH transmission being scheduled to be transmitted before the SRS transmission.

As shown in FIG. 3B, and by reference number 304, the UE 120 may receive the uplink grant and may determine a cyclic prefix extension for transmission of the SRS transmission and the PUSCH transmission. In particular, the UE 120 may determine a duration of the cyclic prefix extension that is to be transmitted with the transmission (e.g., the SRS transmission or the PUSCH transmission) that is scheduled to be performed first. In the example illustrated in FIG. 3B, the UE 120 determines the duration of a cyclic prefix extension that is to be transmitted with the SRS transmission.

The UE 120 may determine the cyclic prefix extension (e.g., the duration of the cyclic prefix extension) based at least in part on one or more parameters for determining a cyclic prefix extension indicated in the uplink grant received from the BS 110. The one or more parameters may be indicated by a bit field that includes one or more bits (e.g., b₁b₂). The value indicated by the bit field may index into a table, a database, a specification, a standard, or another type of data structure. An example table is illustrated in Table 1 below. Other table configurations may be used.

TABLE 1

| b₀b₁ | LBT Type | CP extension |
|---|---|---|
| 0 | Cat-2 16 μs | C2*symbol length - 16 μs - TA |
| 1 | Cat-2 25 μs | C3*symbol length - 25 μs - TA |
| 2 | Cat-2 25 μs | C1*symbol length - 25 μs |
| 3 | Cat-4 | 0 |

As illustrated in Table 1, each possible value of the bit field (or a subset thereof) may index into a row (or column) of the table. The one or more parameters may include an LBT type and information for determining the cyclic prefix extension (CP extension). The LBT type parameter may indicate the type of LBT procedure that the UE 120 is to perform prior to transmitting the SRS transmission and the PUSCH transmission. Examples of LBT types include Category 1 (Cat-1) LBT (no LBT procedure is performed), Category 2 (Cat-2) LBT (an LBT procedure that is performed for a particular duration), Category 3 (Cat-3) LBT (an LBT procedure that is performed for a randomly selected duration within a fixed contention window size), Category 4 (Cat-4) LBT (an LBT procedure that is performed for a randomly selected duration within a variable contention window size). For bit field values configured with Cat-2 LBT procedure types, the table may further indicate a threshold LBT timing gap (e.g., 16 μs, 25 μs, and/or the like) between transmissions above which the UE 120 is to perform another LBT procedure. Thus, if the timing gap between uplink transmissions for the UE 120 exceeds a threshold timing gap, the UE 120 is to perform LBT procedures prior to each of the uplink transmissions.

The information for determining the cyclic prefix extension may include an equation for determining the cyclic prefix extension duration, such one of the example equations illustrated above in Table 1 or another equation. As illustrated in Table 1, an equation for determining a cyclic prefix extension may include various parameters, such as C1, C2, C3, a symbol length for the wireless access link on which the BS 110 and the UE 120 communicate, a threshold LBT timing gap, a timing advance (TA) for the UE 120, and/or the like. C1 may be a variable value that is determined based at least in part on the subcarrier spacing (SCS) for the wireless access link on which the BS 110 and the UE 120 communicate. As an example, C1 may be 1 for 15 kilohertz (kHz) SCS and 30 kHz SCS, 2 for 60 kHz SCS, and/or the like. C2 and C3 may be variable values that are configured by BS 110 via RRC signaling.

As shown in FIG. 3C, and by reference number 306, the UE 120 may transmit the SRS transmission with the determined cyclic prefix extension after performing an LBT procedure. For example, the UE 120 may transmit the SRS transmission in the time domain resources and/or the frequency domain resources indicated in the uplink grant. Moreover, the UE 120 may transmit the cyclic prefix extension prior to transmitting the SRS transmission and after performing the LBT procedure. The UE 120 may perform the type of LBT procedure indicated by the bit field in the uplink grant. The UE 120 may transmit the PUSCH transmission in the adjacent time domain resources indicated in the uplink grant after transmitting the SRS transmission.

As indicated above, FIGS. 3A-3C are provided as one or more examples. Other examples may differ from what is described with respect to FIGS. 3A-3C.

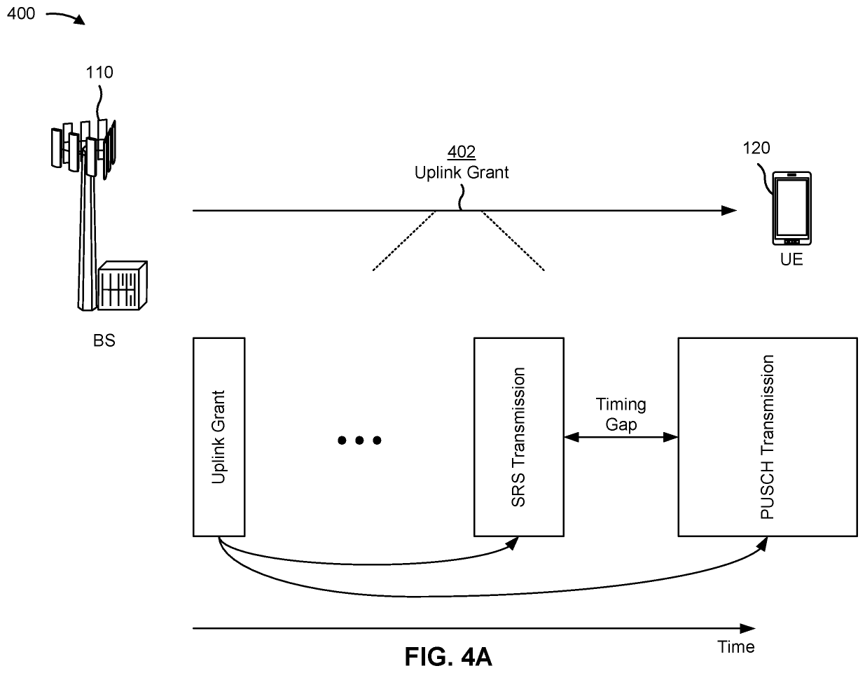

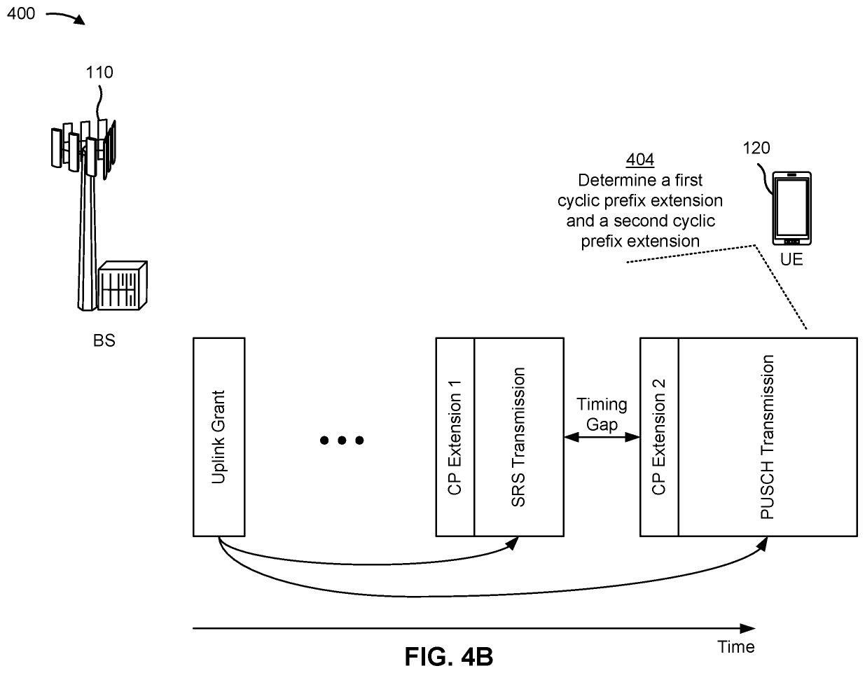

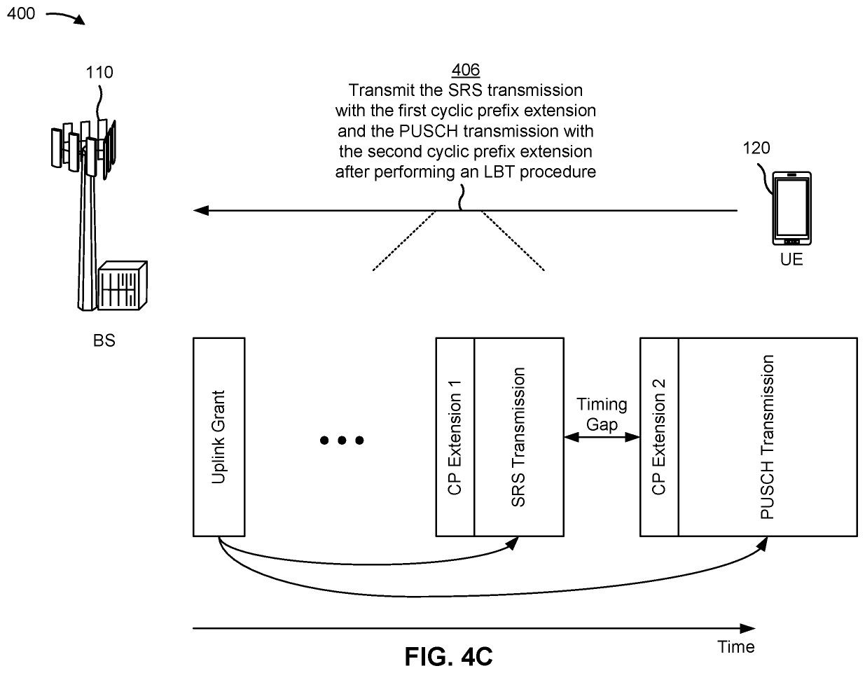

FIGS. 4A-4C are diagrams illustrating one or more examples 400 of determining a cyclic prefix extension for a sounding reference signal transmission in NR-U, in accordance with various aspects of the present disclosure. As shown in FIGS. 4A-4C, example(s) 400 include communication between a BS 110 (e.g., a BS 110 illustrated and described above in connection with FIGS. 1 and/or 2) and a UE 120 (e.g., a UE 120 illustrated and described above in connection with FIGS. 1 and/or 2). The BS 110 and the UE 120 may be included in a wireless network, such as wireless network 100. The BS 110 and the UE 120 may communicate on a wireless access link, which may include an uplink and a downlink. In some aspects, the BS 110 and the UE 120 communicate via a shared radio frequency spectrum band, such as an NR-U band or another type of shared radio frequency spectrum band on which the BS 110, the UE 120, and other wireless communication devices perform an LBT procedure before transmitting on the shared radio frequency spectrum band.

As shown in FIG. 4A, and by reference number 402, the BS 110 may transmit an uplink grant to the UE 120. The uplink grant may schedule a PUSCH transmission and an associated SRS transmission for the UE 120. For example, the uplink grant may identify time domain resources and/or frequency domain resources in which to perform the PUSCH transmission and the SRS transmission. In some aspects, the uplink grant is included in DCI and/or in a PDCCH communication.

As further shown in FIG. 4A, the uplink grant may schedule the SRS transmission and the PUSCH transmission with a timing gap between the transmissions. In this case, the PUSCH transmission and the SRS transmission are to be performed in time domain resources or groups or sets of time domain resources separated by one or more slots, one or more symbols, portions of one or more symbols, and/or the like.

As shown in FIG. 4B, and by reference number 404, the UE 120 may receive the uplink grant and may determine a first cyclic prefix extension (CP Extension 1) for transmission with the SRS transmission and a second cyclic prefix extension (CP Extension 2) for transmission with the PUSCH transmission. In particular, the UE 120 may determine a duration of the first cyclic prefix extension and a duration of the second cyclic prefix extension. The UE 120 may determine the first cyclic prefix extension (e.g., the duration of the first cyclic prefix extension) based at least in part on one or more parameters for determining a cyclic prefix extension indicated in the uplink grant received from the BS 110. The one or more parameters may be indicated by a bit field that includes one or more bits (e.g., b₁b₂). The value indicated by the bit field may index into a table, a database, a specification, a standard, or another type of data structure, such as the example table illustrated in Table 1 above.

The UE 120 may determine the duration of the second cyclic prefix extension such that the timing gap between the SRS transmission and the start of the second cyclic prefix extension satisfies a threshold LBT timing gap. In this way, the UE 120 determines the duration of the second cyclic prefix extension such that another LBT procedure is not needed between the SRS transmission and the PUSCH transmission. In some aspects, the BS 110 transmits an indication of the threshold LBT timing gap (e.g., in the uplink grant or in RRC signaling). In some aspects, the UE 120 is configured or programmed with information identifying the threshold LBT timing gap.

As shown in FIG. 4C, and by reference number 406, the UE 120 may transmit the SRS transmission with the first cyclic prefix extension after performing an LBT procedure. For example, the UE 120 may transmit the SRS transmission in the time domain resources and/or the frequency domain resources indicated in the uplink grant. Moreover, the UE 120 may transmit the first cyclic prefix extension prior to transmitting the SRS transmission and after performing the LBT procedure. The UE 120 may perform the type of LBT procedure indicated by the bit field in the uplink grant. The UE 120 may transmit the PUSCH transmission in the time domain resources indicated in the uplink grant after performing the SRS transmission. The UE 120 may transmit the PUSCH transmission with the second cyclic prefix extension.

As indicated above, FIGS. 4A-4C are provided as one or more examples. Other examples may differ from what is described with respect to FIGS. 4A-4C.

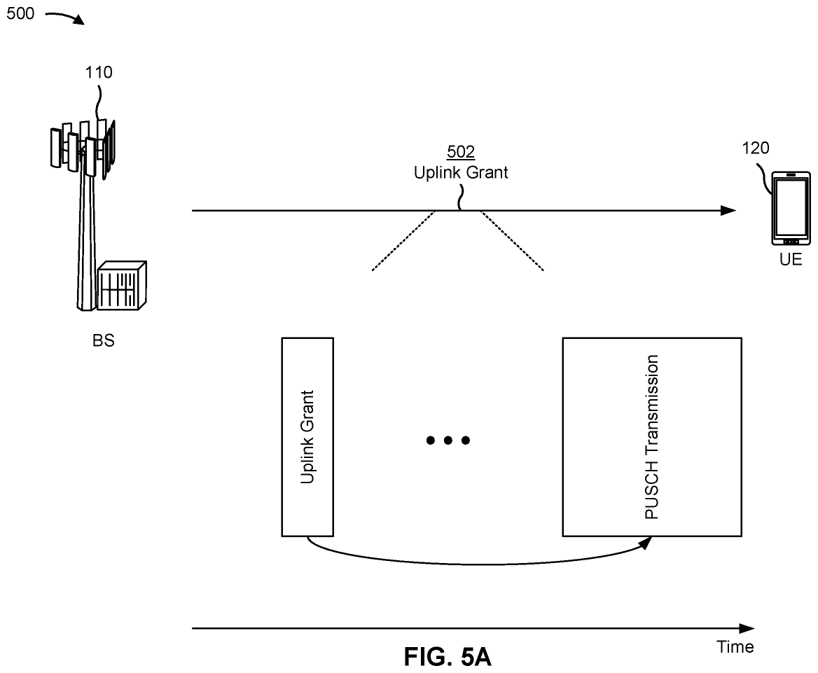

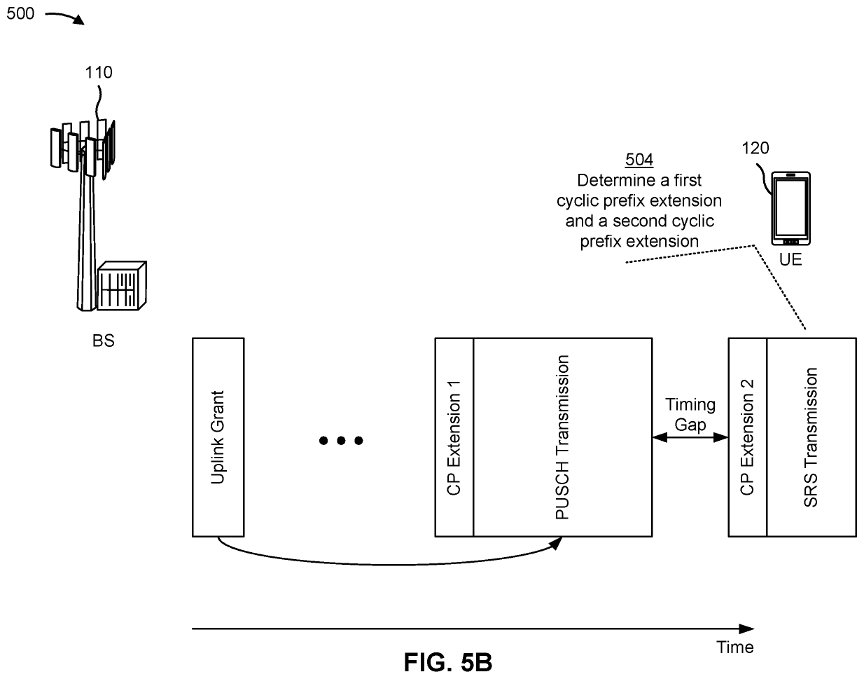

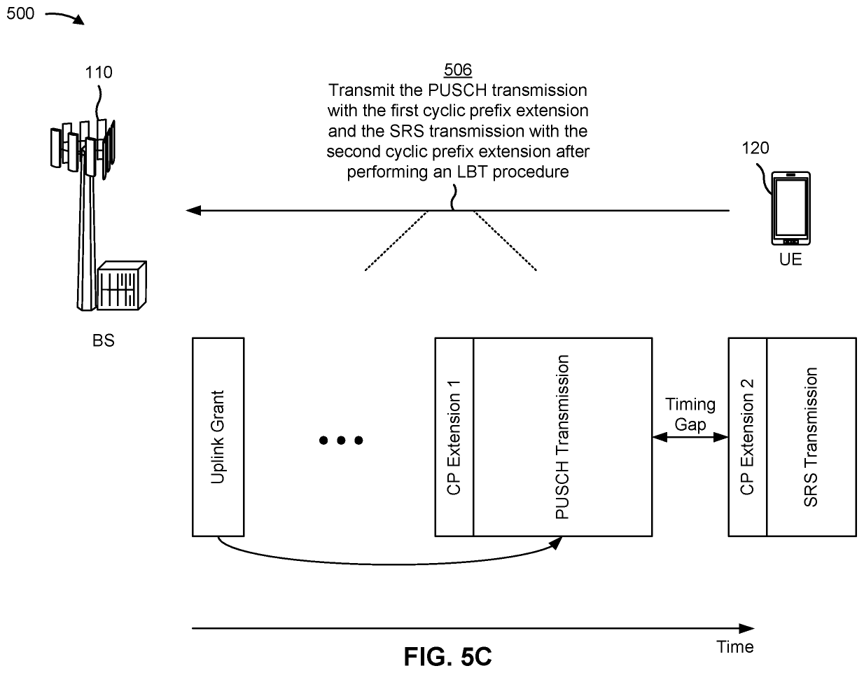

FIGS. 5A-5C are diagrams illustrating one or more examples 500 of determining a cyclic prefix extension for a sounding reference signal transmission in NR-U, in accordance with various aspects of the present disclosure. As shown in FIGS. 5A-5C, example(s) 500 include communication between a BS 110 (e.g., a BS 110 illustrated and described above in connection with FIGS. 1 and/or 2) and a UE 120 (e.g., a UE 120 illustrated and described above in connection with FIGS. 1 and/or 2). The BS 110 and the UE 120 may be included in a wireless network, such as wireless network 100. The BS 110 and the UE 120 may communicate on a wireless access link, which may include an uplink and a downlink. In some aspects, the BS 110 and the UE 120 communicate via a shared radio frequency spectrum band, such as an NR-U band or another type of shared radio frequency spectrum band on which the BS 110, the UE 120, and other wireless communication devices perform an LBT procedure before transmitting on the shared radio frequency spectrum band.

As shown in FIG. 5A, and by reference number 502, the BS 110 may transmit an uplink grant to the UE 120. The uplink grant may schedule a PUSCH transmission for the UE 120. For example, the uplink grant may identify time domain resources and/or frequency domain resources in which to perform the PUSCH transmission. In some aspects, the uplink grant is included in DCI and/or in a PDCCH communication.

As shown in FIG. 5B, the BS 110 may further schedule an SRS transmission for the UE 120. In some aspects, the SRS transmission is scheduled by the uplink grant that schedules the PUSCH transmission. In some aspects, and as illustrated in the example in FIG. 5B, the BS 110 may schedule the SRS transmission to be periodic or semi-persistent via RRC signaling. In this case, the RRC signaling may indicate recurring time domain resources and/or frequency domain resources for the SRS transmission. As shown in FIG. 5B, the SRS transmission may be scheduled to occur after transmission of the PUSCH transmission. Moreover, as shown in FIG. 5B, the SRS transmission may be scheduled to occur after a timing gap after completion of the PUSCH transmission.

As further shown in FIG. 5B, and by reference number 504, the UE 120 may receive the uplink grant and may determine a first cyclic prefix extension (CP Extension 1) for transmission with the PUSCH transmission and a second cyclic prefix extension (CP Extension 2) for transmission with the SRS transmission. In particular, the UE 120 may determine a duration of the first cyclic prefix extension and a duration of the second cyclic prefix extension. The UE 120 may determine the first cyclic prefix extension (e.g., the duration of the first cyclic prefix extension) based at least in part on one or more parameters for determining a cyclic prefix extension indicated in the uplink grant received from the BS 110. The one or more parameters may be indicated by a bit field that includes one or more bits (e.g., b₁b₂). The value indicated by the bit field may index into a table, a database, a specification, a standard, or another type of data structure, such as the example table illustrated in Table 1 above.

The UE 120 may determine the duration of the second cyclic prefix extension such that the timing gap between the PUSCH transmission and the start of the second cyclic prefix extension satisfies a threshold LBT timing gap. In this way, the UE 120 determines the duration of the second cyclic prefix extension such that another LBT procedure is not needed between the PUSCH transmission and the SRS transmission. In some aspects, the BS 110 transmits an indication of the threshold LBT timing gap (e.g., in the uplink grant or in RRC signaling). In some aspects, the UE 120 is configured or programmed with information identifying the threshold LBT timing gap.

As shown in FIG. 5C, and by reference number 506, the UE 120 may transmit the PUSCH transmission with the first cyclic prefix extension after performing an LBT procedure. For example, the UE 120 may transmit the PUSCH transmission in the time domain resources and/or the frequency domain resources indicated in the uplink grant. Moreover, the UE 120 may transmit the first cyclic prefix extension prior to transmitting the PUSCH transmission and after performing the LBT procedure. The UE 120 may perform the type of LBT procedure indicated by the bit field in the uplink grant. The UE 120 may transmit the SRS transmission in the time domain resources indicated in the uplink grant after performing the PUSCH transmission. The UE 120 may transmit the SRS transmission with the second cyclic prefix extension.

As indicated above, FIGS. 5A-5C are provided as one or more examples. Other examples may differ from what is described with respect to FIGS. 5A-5C.

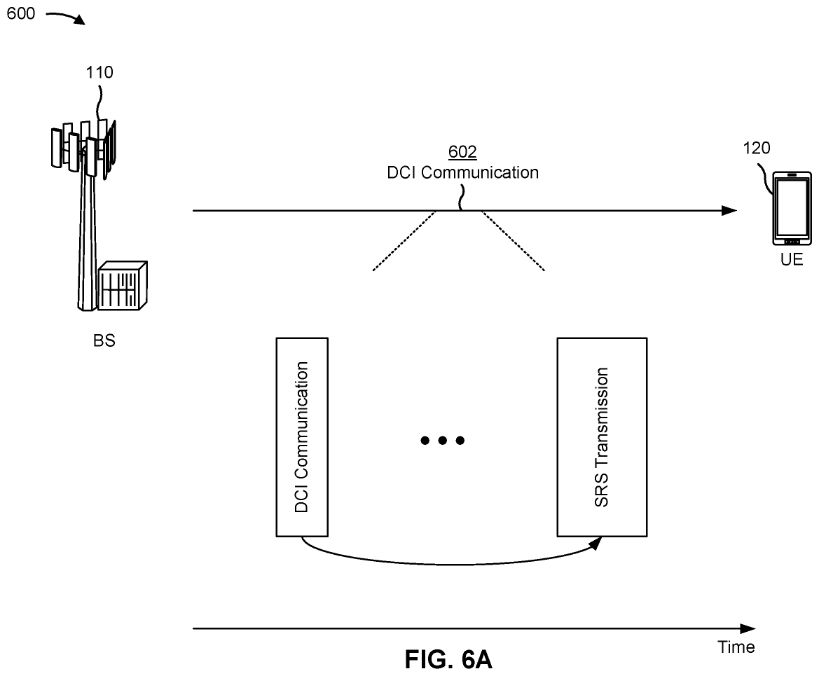

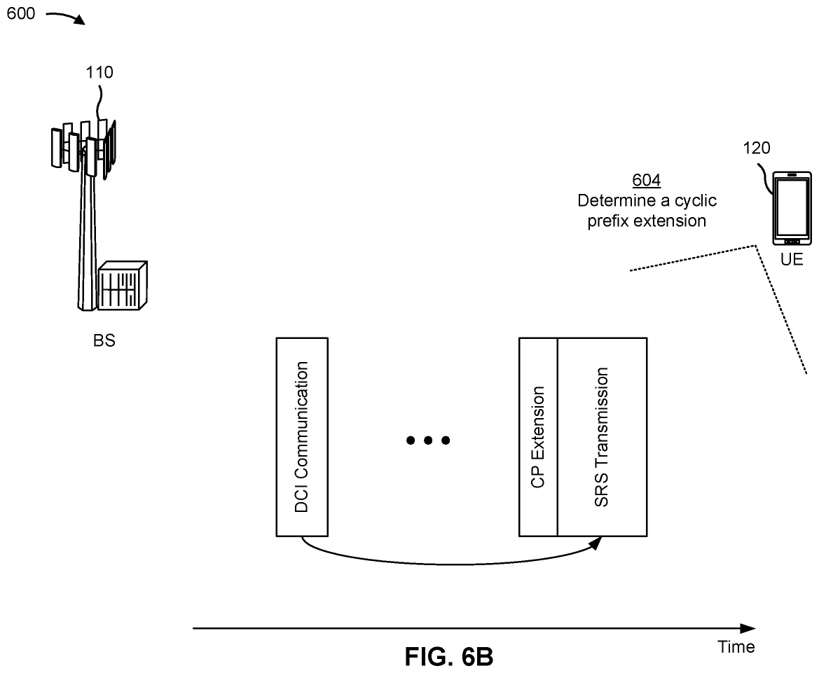

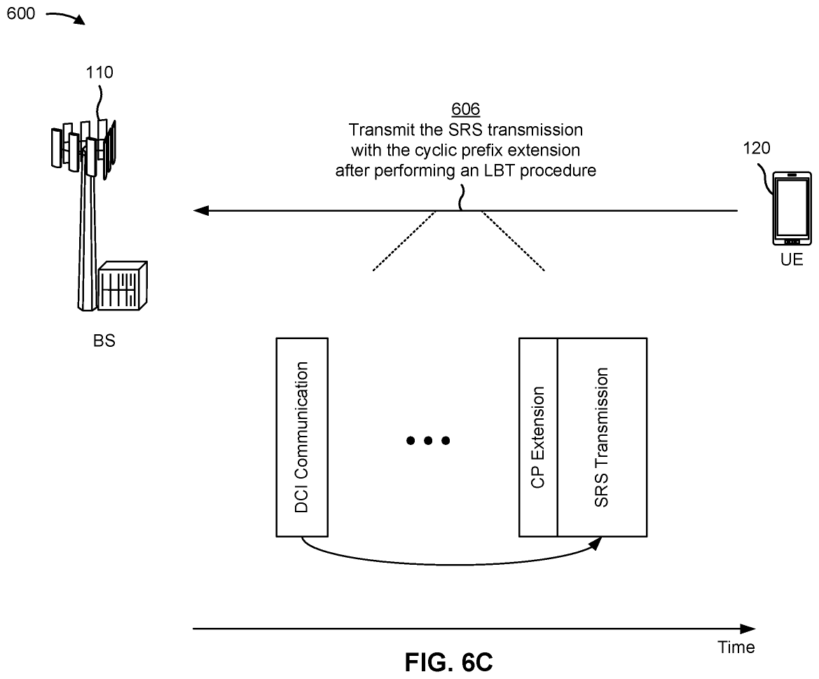

FIGS. 6A-6C are diagrams illustrating one or more examples 600 of determining a cyclic prefix extension for a sounding reference signal transmission in NR-U, in accordance with various aspects of the present disclosure. As shown in FIGS. 6A-6C, example(s) 600 include communication between a BS 110 (e.g., a BS 110 illustrated and described above in connection with FIGS. 1 and/or 2) and a UE 120 (e.g., a UE 120 illustrated and described above in connection with FIGS. 1 and/or 2). The BS 110 and the UE 120 may be included in a wireless network, such as wireless network 100. The BS 110 and the UE 120 may communicate on a wireless access link, which may include an uplink and a downlink. In some aspects, the BS 110 and the UE 120 communicate via a shared radio frequency spectrum band, such as an NR-U band or another type of shared radio frequency spectrum band on which the BS 110, the UE 120, and other wireless communication devices perform an LBT procedure before transmitting on the shared radio frequency spectrum band.

As shown in FIG. 6A, and by reference number 602, the BS 110 may transmit a DCI communication to the UE 120. In some aspects, the DCI communication may trigger the UE 120 to perform SRS transmission for the UE 120. In these cases, the DCI communication may include a downlink grant on a PDCCH. In some aspects, the DCI communication may be a DCI format (e.g., DCI format 2_3) that indicates a transmit power control (TPC) command and an SRS resource indicator for the UE 120. In these cases, the DCI communication may identify time domain resources and/or frequency domain resources in which to perform the SRS transmission. Moreover, the TPC command may indicate or may be used to determine the transmit power at which the UE 120 is to transmit the SRS transmission.

As shown in FIG. 6B, and by reference number 604, the UE 120 may receive the uplink grant and may determine a cyclic prefix extension (CP Extension) for transmission with the SRS transmission. In particular, the UE 120 may determine a duration of the cyclic prefix extension. The UE 120 may determine the cyclic prefix extension (e.g., the duration of the cyclic prefix extension) based at least in part on one or more parameters for determining a cyclic prefix extension indicated in the DCI communication or in RRC signaling received from the BS 110. The one or more parameters may be indicated by a bit field that includes one or more bits (e.g., b₁b₂). The value indicated by the bit field may index into a table, a database, a specification, a standard, or another type of data structure, such as example table is illustrated in Table 1 above.

As shown in FIG. 6C, and by reference number 606, the UE 120 may transmit the SRS transmission with the cyclic prefix extension after performing an LBT procedure. For example, the UE 120 may transmit the SRS transmission in the time domain resources and/or the frequency domain resources indicated in the DCI communication. Moreover, the UE 120 may transmit the cyclic prefix extension prior to transmitting the SRS transmission and after performing the LBT procedure.

As indicated above, FIGS. 6A-6C are provided as one or more examples. Other examples may differ from what is described with respect to FIGS. 6A-6C.

FIG. 7 is a diagram illustrating an example process 700 performed, for example, by a UE, in accordance with various aspects of the present disclosure. Example process 700 is an example where the UE (e.g., UE 120 illustrated and described above in connection with one or more of FIGS. 1, 2, 3A-3C, 4A-4C, 5A-5C, and/or 6A-6C, and/or the like) performs operations associated with determining a cyclic prefix extension for a sounding reference signal transmission in NR-U.

As shown in FIG. 7, in some aspects, process 700 may include receiving an uplink grant that schedules an SRS transmission and a PUSCH transmission and indicates one or more parameters for determining a cyclic prefix extension (block 710). For example, the UE (e.g., using receive processor 258, transmit processor 264, controller/processor 280, memory 282, and/or the like) may receive an uplink grant that schedules an SRS transmission and a PUSCH transmission and indicates one or more parameters for determining a cyclic prefix extension, as described above.

As further shown in FIG. 7, in some aspects, process 700 may include determining the cyclic prefix extension based at least in part on the one or more parameters (block 720). For example, the UE (e.g., using receive processor 258, transmit processor 264, controller/processor 280, memory 282, and/or the like) may determine the cyclic prefix extension based at least in part on the one or more parameters, as described above.

As further shown in FIG. 7, in some aspects, process 700 may include transmitting the SRS transmission with the cyclic prefix extension after performing an LBT procedure (block 730). For example, the UE (e.g., using receive processor 258, transmit processor 264, controller/processor 280, memory 282, and/or the like) may transmit the SRS transmission with the cyclic prefix extension after performing an LBT procedure, as described above.

Process 700 may include additional aspects, such as any single aspect or any combination of aspects described below and/or in connection with one or more other processes described elsewhere herein.

In a first aspect, the uplink grant includes one or more bits that indicate the one or more parameters for determining the cyclic prefix extension, and the one or more parameters include an LBT type and information for determining the cyclic prefix extension. In a second aspect, alone or in combination with the first aspect, the uplink grant schedules the SRS transmission to occur before the PUSCH transmission; the uplink grant schedules the SRS transmission and the PUSCH transmission without a timing gap between the SRS transmission and the PUSCH transmission, and process 700 includes transmitting the PUSCH transmission after transmitting the SRS transmission.

In a third aspect, alone or in combination with one or more of the first and second aspects, the uplink grant schedules the SRS transmission to occur before the PUSCH transmission; the uplink grant schedules the SRS transmission and the PUSCH transmission with a timing gap between the SRS transmission and the PUSCH transmission, and process 700 includes determining another cyclic prefix extension based at least in part on a duration of the timing gap; and transmitting, after transmitting the SRS transmission, the PUSCH transmission with the other cyclic prefix extension. In a fourth aspect, alone or in combination with one or more of the first through third aspects, determining the other cyclic prefix extension includes determining a duration of the other cyclic prefix extension to reduce the duration of the timing gap between the SRS transmission and the PUSCH transmission such that another LBT procedure is not needed for the PUSCH transmission.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with various aspects of the present disclosure. Example process 800 is an example where the UE (e.g., UE 120 illustrated and described above in connection with one or more of FIGS. 1, 2, 3A-3C, 4A-4C, 5A-5C, and/or 6A-6C, and/or the like) performs operations associated with determining a cyclic prefix extension for a sounding reference signal transmission in NR-U.

As shown in FIG. 8, in some aspects, process 800 may include receiving an uplink grant that schedules a PUSCH transmission and indicates one or more parameters for determining a first cyclic prefix extension (block 810). For example, the UE (e.g., using receive processor 258, transmit processor 264, controller/processor 280, memory 282, and/or the like) may receive an uplink grant that schedules a PUSCH transmission and indicates one or more parameters for determining a first cyclic prefix extension, as described above.

As further shown in FIG. 8, in some aspects, process 800 may include determining a second cyclic prefix extension for an SRS transmission to be transmitted after a timing gap after the PUSCH transmission (block 820). For example, the UE (e.g., using receive processor 258, transmit processor 264, controller/processor 280, memory 282, and/or the like) may determine a second cyclic prefix extension for an SRS transmission to be transmitted after a timing gap after the PUSCH transmission, as described above.

As further shown in FIG. 8, in some aspects, process 800 may include transmitting the SRS transmission with the second cyclic prefix extension after transmitting the PUSCH transmission (block 830). For example, the UE (e.g., using receive processor 258, transmit processor 264, controller/processor 280, memory 282, and/or the like) may transmit the SRS transmission with the second cyclic prefix extension after transmitting the PUSCH transmission, as described above.

Process 800 may include additional aspects, such as any single aspect or any combination of aspects described below and/or in connection with one or more other processes described elsewhere herein.

In a first aspect, the uplink grant includes one or more bits that indicate the one or more parameters for determining the cyclic prefix extension, and the one or more parameters include an LBT type and information for determining the first cyclic prefix extension. In a second aspect, alone or in combination with the first aspect, process 800 includes determining the first cyclic prefix extension for the PUSCH transmission; performing an LBT procedure; and transmitting the PUSCH transmission with the first cyclic prefix extension after performing the LBT procedure.

In a third aspect, alone or in combination with one or more of the first and second aspects, determining the second cyclic prefix extension comprises determining a duration of the second cyclic prefix extension to reduce a duration of the timing gap between the SRS transmission and the PUSCH transmission such that another LBT procedure is not needed for the SRS transmission. In a fourth aspect, alone or in combination with one or more of the first through third aspects, the SRS transmission is a periodic or semi-persistent SRS transmission. In a fifth aspect, alone or in combination with one or more of the first through fourth aspects, the SRS transmission is an aperiodic SRS transmission scheduled by the uplink grant.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with various aspects of the present disclosure. Example process 900 is an example where the UE (e.g., UE 120 illustrated and described above in connection with one or more of FIGS. 1, 2, 3A-3C, 4A-4C, 5A-5C, and/or 6A-6C, and/or the like) performs operations associated with determining a cyclic prefix extension for a sounding reference signal transmission in NR-U.

As shown in FIG. 9, in some aspects, process 900 may include receiving a DCI communication that schedules an SRS transmission and indicates one or more parameters for determining a cyclic prefix extension (block 910). For example, the UE (e.g., using receive processor 258, transmit processor 264, controller/processor 280, memory 282, and/or the like) may receive a DCI communication that schedules an SRS transmission and indicates one or more parameters for determining a cyclic prefix extension, as described above.

As further shown in FIG. 9, in some aspects, process 900 may include determining the cyclic prefix extension based at least in part on the one or more parameters (block 920). For example, the UE (e.g., using receive processor 258, transmit processor 264, controller/processor 280, memory 282, and/or the like) may determine the cyclic prefix extension based at least in part on the one or more parameters, as described above.

As further shown in FIG. 9, in some aspects, process 900 may include transmitting an SRS transmission with the cyclic prefix extension after performing an LBT procedure (block 930). For example, the UE (e.g., using receive processor 258, transmit processor 264, controller/processor 280, memory 282, and/or the like) may transmit an SRS transmission with the cyclic prefix extension after performing an LBT procedure, as described above.

Process 900 may include additional aspects, such as any single aspect or any combination of aspects described below and/or in connection with one or more other processes described elsewhere herein.

In a first aspect, the DCI communication includes one or more bits that indicate the one or more parameters for determining the cyclic prefix extension, and the one or more parameters include an LBT type and information for determining the cyclic prefix extension. In a second aspect, alone or in combination with the first aspect, the DCI communication indicates a TPC command for the SRS transmission. In a third aspect, alone or in combination with one or more of the first and second aspects, the DCI communication includes a PDCCH downlink grant that triggers the SRS transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving an uplink grant that:
schedules a sounding reference signal (SRS) transmission and a physical uplink shared channel (PUSCH) transmission, and
indicates one or more parameters for determining a cyclic prefix extension;
determining the cyclic prefix extension based at least in part on the one or more parameters; and
transmitting the SRS transmission with the cyclic prefix extension after performing a listen before talk (LBT) procedure.

2. The method of claim 1, wherein the uplink grant includes one or more bits that indicate the one or more parameters for determining the cyclic prefix extension; and
wherein the one or more parameters include:
an LBT type, and
information for determining the cyclic prefix extension.

3. The method of claim 1, wherein the uplink grant schedules the SRS transmission to occur before the PUSCH transmission;
wherein the uplink grant schedules the SRS transmission and the PUSCH transmission without a timing gap between the SRS transmission and the PUSCH transmission; and
wherein the method further comprises:
transmitting the PUSCH transmission after transmitting the SRS transmission.

4. The method of claim 1, wherein the uplink grant schedules the SRS transmission to occur before the PUSCH transmission;
wherein the uplink grant schedules the SRS transmission and the PUSCH transmission with a timing gap between the SRS transmission and the PUSCH transmission; and
wherein the method further comprises:
determining another cyclic prefix extension based at least in part on a duration of the timing gap; and
transmitting, after transmitting the SRS transmission, the PUSCH transmission with the other cyclic prefix extension.

5. The method of claim 4, wherein determining the other cyclic prefix extension comprises:
determining a duration of the other cyclic prefix extension to reduce the duration of the timing gap between the SRS transmission and the PUSCH transmission such that another LBT procedure is not needed for the PUSCH transmission.

6. A method of wireless communication performed by a user equipment (UE), comprising:
receiving an uplink grant that:
schedules a physical uplink shared channel (PUSCH) transmission, and
indicates one or more parameters for determining a first cyclic prefix extension;
determining a second cyclic prefix extension for a sounding reference signal (SRS) transmission to be transmitted after a timing gap after the PUSCH transmission; and
transmitting the SRS transmission with the second cyclic prefix extension after transmitting the PUSCH transmission.

7. The method of claim 6, wherein the uplink grant includes one or more bits that indicate the one or more parameters for determining the cyclic prefix extension; and
wherein the one or more parameters include:
an LBT type, and
information for determining the first cyclic prefix extension.

8. The method of claim 6, further comprising:
determining the first cyclic prefix extension for the PUSCH transmission;
performing a listen before talk (LBT) procedure; and
transmitting the PUSCH transmission with the first cyclic prefix extension after performing the LBT procedure.

9. The method of claim 6, wherein determining the second cyclic prefix extension comprises:
determining a duration of the second cyclic prefix extension to reduce a duration of the timing gap between the SRS transmission and the PUSCH transmission such that another listen before talk (LBT) procedure is not needed for the SRS transmission.

10. The method of claim 6, wherein the SRS transmission is a periodic or semi-persistent SRS transmission.

11. The method of claim 6, wherein the SRS transmission is an aperiodic SRS transmission scheduled by the uplink grant.

12. A method of wireless communication performed by a user equipment (UE), comprising:
receiving a downlink control information (DCI) communication that:
schedules a sounding reference signal (SRS) transmission, and
indicates one or more parameters for determining a cyclic prefix extension;
determining the cyclic prefix extension based at least in part on the one or more parameters; and
transmitting a sounding reference signal (SRS) transmission with the cyclic prefix extension after performing a listen before talk (LBT) procedure.

13. The method of claim 12, wherein the DCI communication includes one or more bits that indicate the one or more parameters for determining the cyclic prefix extension; and
wherein the one or more parameters include:
a listen before talk (LBT) type, and
information for determining the cyclic prefix extension.

14. The method of claim 12, wherein the DCI communication indicates a transmit power control (TPC) command for the SRS transmission.

15. The method of claim 12, wherein the DCI communication includes a physical downlink control channel (PDCCH) downlink grant that triggers the SRS transmission.

16. A user equipment (UE) for wireless communication, comprising:
a memory; and
one or more processors operatively coupled to the memory, the memory and the one or more processors configured to:
receive an uplink grant that:
schedules a sounding reference signal (SRS) transmission and a physical uplink shared channel (PUSCH) transmission, and
indicates one or more parameters for determining a cyclic prefix extension;
determine the cyclic prefix extension based at least in part on the one or more parameters; and
transmit the SRS transmission with the cyclic prefix extension after performing a listen before talk (LBT) procedure.

17.-24. (canceled)

25. The UE of claim 16, wherein the uplink grant includes one or more bits that indicate the one or more parameters for determining the cyclic prefix extension; and
wherein the one or more parameters include:
an LBT type, and
information for determining the cyclic prefix extension.

26. The UE of claim 16, wherein the uplink grant schedules the SRS transmission to occur before the PUSCH transmission;
wherein the uplink grant schedules the SRS transmission and the PUSCH transmission without a timing gap between the SRS transmission and the PUSCH transmission; and
wherein the one or more processors are further configured to:
transmit the PUSCH transmission after transmitting the SRS transmission.

27. The UE of claim 16, wherein the uplink grant schedules the SRS transmission to occur before the PUSCH transmission;
wherein the uplink grant schedules the SRS transmission and the PUSCH transmission with a timing gap between the SRS transmission and the PUSCH transmission; and
wherein the one or more processors are further configured to:
determine another cyclic prefix extension based at least in part on a duration of the timing gap; and
transmit, after transmitting the SRS transmission, the PUSCH transmission with the other cyclic prefix extension.

28. The UE of claim 27, wherein the one or more processors, to determine the other cyclic prefix extension, are configured to:
determine a duration of the other cyclic prefix extension to reduce the duration of the timing gap between the SRS transmission and the PUSCH transmission such that
